(19) United States
(12) Patent Application Publication
(10) Pub. No.: US 2008/0301060 A1
(43) Pub. Date: Dec. 4, 2008

(54) METHOD FOR VALUATION AND SALE OF PRIVATE EQUITY TO ACCREDITED INVESTORS BY MEANS OF A RANKED, ALGORITHMIC, DUE DILIGENCE PROCESS

(76) Inventor: William M. Ayers, Princeton, NJ (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/131,530

(22) Filed: Jun. 2, 2008

Related U.S. Application Data
(60) Provisional application No. 60/941,078, filed on May 31, 2007.

(51) Int. Cl. G06Q 40/00; G06F 17/16

(52) U.S. Cl. 705/36 R

(57) ABSTRACT

A computer implemented method to provide a valuation estimate and secondary market exchange for private equity securities is disclosed. The valuation of the security is accomplished through a performance ranking in which time dependent values of multiple quantitative and weighted qualitative factors are calculated to provide a automated surrogate method for a traditional due diligence valuation. This method greatly facilitates the valuation analysis and liquidity of the private equity. The market participants are limited to US Securities and Exchange Commission defined accredited investors.

### REFERENCE TO RELATED APPLICATION

The present application claims the benefit of U.S. Provisional Patent Application Ser. No. 60/941,078 filed May 31, 2007 entitled “METHOD FOR VALUATION AND SALE OF PRIVATE EQUITY TO ACCREDITED INVESTORS BY MEANS OF A RANKED, ALGORITHIMIC, DUE DILLIGENCE PROCESS” which is hereby incorporated by reference in its entirety to the extent it is not inconsistent.

### BACKGROUND OF THE INVENTION

Private equity is defined as shares in a private company or partnership that are not listed on a public stock exchange. These private shares may initially be issued by entities such as start-up companies, venture capital funds, limited partnerships, and companies that are seeking capital.

The number of potential buyers, and hence the market liquidity, for private equity is small compared with that of public equity. The public is not allowed to buy private equity shares unless the offering company registers them through the United States Securities and Exchange Commission (S.E.C.). However, under S.E.C. Rule 501, Regulation D of the amended Securities Act of 1933, the S.E.C. allows the sale or purchase of private equity to private groups defined as qualified institutional investors and accredited investors. These groups have eight subcategories including; banks, insurance companies, investment advisors, charitable organizations, partnerships, and trusts with assets greater than $5 million dollars as well as individuals with a net worth greater than $1 million dollars. Because of their wealth and investment experience, the S.E.C. assumes this group can comprehend, assess, and subsequently assume the greater risk associated with private equity investments.

Once private equity shares are issued in an initial offering, their private resale to other parties is further restricted by S.E.C rules. Hicks extensively covers the requirements for such resales under S.E.C Sections 4(1) and 4(2). These restrictions are also known to practitioners as hybrid Section 4(½). The resale market for such private securities is small and very illiquid. Hence, private resales have historically been accomplished by word of mouth between individuals, registered broker-dealers, or institutions.

One major obstacle to the resale of private equity is estimating its value and the risk or error associated in determining the valuation. With a public market, such as the New York Stock Exchange, the value of an equity can be priced or valued at anytime during the day. However, since resale of private equity has no such electronic, mark to market, process, the value of the equity has to be determined through an analysis of many factors associated with the equity.

Traditionally, this process of establishing the private equity value is known as due diligence. It is usually performed by certified professional accountants or other investment professionals. However, limited access to financial data, company operations, and subjective factors, such as good will, makes due diligence analysis very difficult compared to publicly traded companies. Lack of standard accounting practices, uniform accounting periods, and a governmental supervising body further complicates the due diligence process. These limitations in performing traditional due diligence makes it very difficult to quickly and accurately value and resell previously issued private equity shares.

A computer implemented method to determine a valuation estimate for previously issued private equity is desirable since potential buyers would have a consistent means to value and rank such shares. The useful benefits of this valuation method for equities would be a reduction in financial risk for buyers of the private equity and enhanced marketability of the shares for the seller.

### SUMMARY OF THE INVENTION

In one form, the invention provides a computer implemented method for estimating the value of previously issued private equity securities. The method can be carried out on the world-wide web (WWW) or on private intranets, networks, or the like. The method provides a more efficient, consistent, and automated means of valuation of private equity securities than traditional methods.

In a further form, the invention provides a computer implemented method for the sale of previously issued equity securities based upon their estimated value.

In one embodiment, the valuation estimation method disclosed is a computer implemented software algorithm which utilizes a numeric matrix of both quantitative and weighted qualitative time dependent factors associated with each selected private equity. Various linear algebraic operations are executed on the matrix of factors in order to arrive at a valuation estimate. The resulting valuation estimate is then used to further calculate a ranking for a private equity within a market sector.

In its further form, as more private equity is valued and resold utilizing the method, a database of final equity sale prices versus their estimated valuations is created. The statistical relationship between the valuation estimate and sales price can then be used to correct the weighting parameters for the qualitative aspects of the equity valuation. Such iterative modification of these weighing parameters leads to improved estimation process and an increase in the accuracy of the probable share price calculated with respect to future sales.

This summary is provided to introduce a selection of concepts in a simplified form that are described in further detail in the detailed description and drawings contained herein. This Summary is not intended to identify key features or essential features of the claimed subject matter, nor is it intended to be used as an aid in determining the scope of the claimed subject matter. Yet other forms, embodiments, objects, advantages, benefits, features, and aspects of the present invention will become apparent from the detailed description and drawings contained herein.

### BRIEF DESCRIPTION OF THE DRAWINGS

FIG. 1A is a process flow diagram illustrating the steps performed according to one embodiment of the present invention in calculating value, ranking, and reselling a private equity security.

FIG. 1B is a continuation of the process of FIG. 1A.

FIG. 2 is a graph of the price vs. the number of sales of a specific private equity which illustrates the improvement and convergence of the valuation algorithm to the actual sales price given an increasing number of equity sales.

### DESCRIPTION OF THE PREFERRED EMBODIMENTS

Individual restricted share investors, or angel investors, often purchase shares in early stage private companies. These angel investors are expected to hold their investment in the private company for three to five years. However, some investors may need to sell their shares before then, due to one of many reasons. In that event, the investor was traditionally forced to ask that the company founder or other company shareholders buy back the investor's shares. In the absence of this computer implemented share valuation estimate method, an extraordinary amount of effort is often needed to find and convince another investor to buy the company shares at a price which is deemed fair by both parties.

According to one form of the present invention, a computer implemented method to provide a valuation estimate and resale of private equity securities over a networked communication system to private investors is provided. The method of provides a valuation estimate as determined by a computational algorithm comprised of; input and storage of a matrix of numerical factors from quantitative and qualitative information about said security, performing linear algebraic and other calculations on said matrix, converting said matrix calculations to a valuation estimate number, and determining a valuation estimate ranking for the security within a group of similar private security listings. In one further form, the quantitative and qualitative information is periodically extracted from electronic databases and sources.

The valuation estimate algorithm includes the construction of a matrix which is preferably includes intellectual property data associated with said security. This intellectual property data may include, by non-limiting example, the number of: issued patents, patent applications, patent citations by other patents or applications, patent news citations, patent licenses, joint ventures. In further and other forms, the matrix is partially comprised of venture capital fund data associated with the initial sale of said security by the originating venture fund including but not limited to: the number of venture fund co-investors, the venture fund rank in industry surveys, the venture fund lead manager rank in industry surveys, number of initial public offerings by the venture fund, number of companies sold through merger or acquisition by the venture fund.

Additionally, the matrix may include university affiliated investor group data associated with the original sale of said security including but not limited to: university rank in surveys, number of affiliate group original investors, affiliate group completed initial public offerings, affiliate group companies sold by merger or acquisition, affiliate group news citations. Other data types include angel investor data associated with the original sale of said equity including but not limited to: angel group membership in the Angel Capital Association, number of original investors, angel group companies sold by merger or acquisition, angel group news citations. Finally, the matrix may also include financial data including but not limited to: the original equity purchase price, number of outstanding shares, revenue history, margin history, revenue growth rate, earnings estimate, and commercial bank prime interest rate.

In one further form, the matrix may also include numeric weighting factors ascribed to qualitative information from the group comprising: class of shares offered (common or preferred), issuing entity restrictions on security sale, security technology sector, published sector rotation prominence. The factors may be modified by a computer implemented statistical correlation between the final private security resale price and the equity valuation estimate ranking thereby providing an iterative improvement of the weighting factors.

According to another form of the described method, the resale of the private security listed on the networked communication system may be accomplished via a sale at a set price with no time limit, a sale at a set price within a prescribed time limit, a sale within a range of a minimum and maximum price based on the valuation estimate, or a sale at a maximum price above the valuation estimate.

It shall be appreciated that the type of private equity securities described is preferably those defined by the United States Securities and Exchange Commission Section D, Rule 144 as restricted shares or limited partnership interests. Additionally, the private investors are preferably defined as those allowed to participate in private resales under United States Securities and Exchange Commission Section 4(1) and 4(2). In these forms, the private investor is preferably provided a Rule 144 resale opinion letter based on the valuation estimate.

Turning to a detailed description of the embodiments, the illustrative system and method facilitates the estimation of value and sale of private corporation shares using a networked communication system, such as a network of computers. Utilizing the communication system, the angel investor would list their shares for valuation and resale. According to the illustrated embodiment, listing the shares requires the input of a subset of the factors illustrated in Table 1 below.

TABLE 1

| Parameter | Quantitative Value |
|---|---|
| Equity Source | |
| individual/angel | 1 |
| Venture capital fund | 2 |
| Angel group affiliation | |
| MIT Enterprise Forum | 0 |
| Stanford | 0 |
| Keritusu Forum | 0 |
| Other University group | 0 |
| Other Angel Group | 0 |
| VC fund name | |
| trade 1 position | 1 to 100 |
| number of IPOs | |
| years operating | |
| Fund manager | |
| trade 1 position | 1 to 100 |
| number of IPOs | |
| number of acquisitions | |
| years at firm | |
| Share Information | |
| Class of shares | |
| common | 1 |
| preferred | 2 |
| Number of shares | |
| low <100 | 1 |
| high >101 | 2 |
| Purchase date (year) | |
| <5 years | |
| >ten years ago | |
| Location | |
| DUNS Number | |
| Sector focus | |
| 1 to 10 | |
| biotech | |
| health | |
| information | |
| media | |
| security | |
| materials | |
| semiconductors | |
| nanotech | |
| industrial | |
| Revenues | |
| revenue range $mill | |
| 0-0.1 | |
| 0.1-1 | |
| 1 to 5 | |
| >5 | |
| revenue growth rate 1-100% | 11 |
| not profitable | |
| profit | |
| gross margin % | 40 |
| Management team | |
| management size <5 | |
| management years >5 | |
| Intellectual Property | |
| patents issued | 4 |
| patents filed | 8 |
| patent citations | 22 |
| patents? | |
| no | |
| yes | |
| New citations | |
| number in last 12 months | 35 |
| Joint ventures | |
| no | |
| yes | |
| Net present value calc | |
| purchase date | |
| LIBOR rate | 0.0625 |
| Equity shale restrictions | |
| none | |
| general partner limits | |
| other | |
| Pending material litigations | |
| no | |
| yes | |

The subset of factors utilized preferably includes the year of equity purchase, common or preferred shares, number of shares, original purchase price, development stage, revenue range, technology sector, and other parameters. Both qualitative and quantitative factors may be requested and utilized. In the preferred form, a qualitative factor is converted by the valuation algorithm into a quantitative parameter with a separately determined weighting factor. These input factors along with other information retrieved from web based commercial databases are combined by the algorithm as a basis in the valuation estimate.

One such qualitative input is technology sector rotation. Sector rotation refers to the cyclic nature of investor interest or sentiment in different technologies. Industry sectors such as biotechnology, energy, materials, consumer goods, or health care rotate in their appeal to investors depending on profitability or technology breakthroughs. Such sector rotation data can also be used as a weighting factor in calculating a premium or discount in the valuation estimate algorithm for the private equity. If the current sector rotation data show the biotechnology sector with the highest sentiment (for example, number 1 out of a possible 20 sectors) then the valuation algorithm for a private equity in biotechnology would add a premium or increase the valuation weighting factor. Conversely, an out of favor sentiment for a private equity in that sector would be assigned a discount weighting in the valuation estimate algorithm. Sector rotation data is available from on-line commercial sources such as Thompson Financial Services and Zack's Sector Rotation.

Another qualitative factor is the association of a private company with a major research university. Massachusetts Institute of Technology, Stanford, and Princeton have affiliated angel investors groups to help finance new companies spun off from university research. The M. I. T. Enterprise Forum and the Princeton Entrepreneur Network are such angel investment groups. The Miliken Institute ranks the success of University associated spin-off companies. The valuation algorithm can convert the qualitative university association to a quantitative weighting factor with that score.

Quantitative data from commercial web-based sources can also be scanned and retrieved by the computer based valuation algorithm. Data such as the number of patents held by the company, the number of cross-citations to those patents in new filings, and news stories on the company would be retrieved and stored for use by the algorithm. On-line sources such as trade magazines, Thompson Private Equity, Price-Waterhouse Money Tree, Deal.com, Dunn and Bradstreet, and Hoovers.com also provide source for this type of data.

Financial calculations such as net present value and internal rate of return for the private equity company can also be performed as part of the computer based valuation estimate algorithm. This is accomplished with standard financial equations that use the private equity auction listing data on share ownership duration, company revenues for that duration, and web retrieved interest rate data such as the current Prime, LIBOR, or other commercial interest rate.

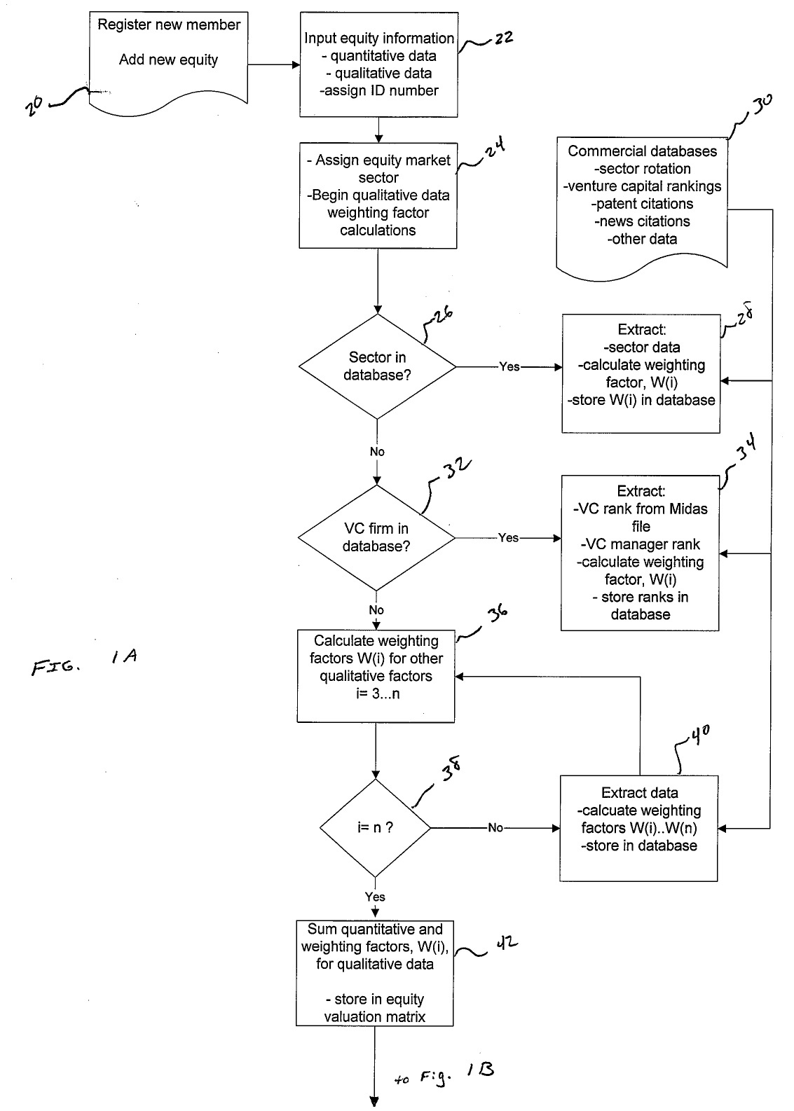

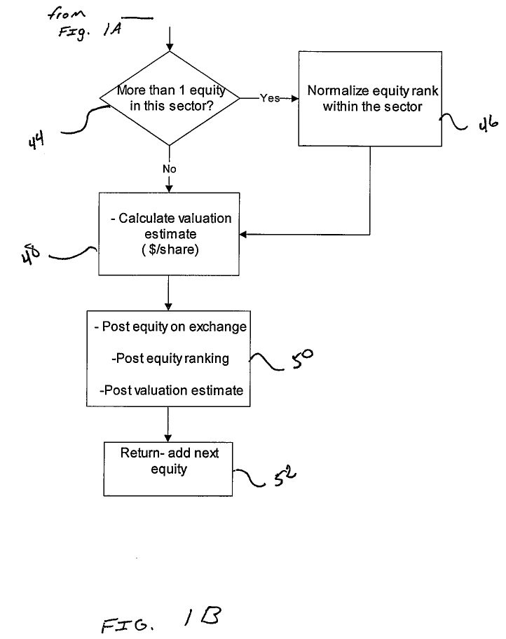

Turning to FIG. 1, a flowchart illustrating the process for calculating a valuation estimate based upon these factors is shown. The process begins at start point 20 with the user registering as a new member, if necessary, in order to add a new equity listing. The user then inputs information associated with the equity, including quantitative and qualitative data (stage 22). Once the data has been provided, the equity is assigned to a market sector and the system begins the calculation of the qualitative data weighing factors, as described herein (stage 24). If the system does not currently have information indicative of the assigned sector (decision 26) then the system collects this data from various sources and stores it (stage 28). Meanwhile, the system is repeatedly retrieving data regarding other information (stage 30). Next, the system determines whether or not it has information regarding the specified venture capital firm associated with the security in its database (decision 32). If not, the system retrieves that information for storage and subsequent use (stage 34).

Once the system has the requisite information, it calculates one of the weighing factors associated with one of the qualitative values (stage 36). Decision 38 and stage 40 ensures that these factors are all calculated. Next, the matrix is constructed using the calculated values (stage 42). If it is determined that there is more than one equity available in the assigned sector (decision 44), then the equity ranks are normalized within the sector in stage 46. Finally, the equity valuation estimate is calculated for the specific equity in stage 48. The equity is then posted on the exchange for others to view and consider (stage 50) along with its ranking and estimate. The process ends at point 52 with the process allowing for the user to return and add an additional equity.

The result of this process according to FIG. 1, and resulting valuation estimate, benefit the potential buyer by reducing the risk associated with purchasing the private equity. The benefit provided to the equity seller is to increase the likelihood of a sale through the reduction in risk and thereby increasing the number of potential buyers.

As each sale is completed, the final price paid for private equity shares and the valuation estimate for each sale is stored in a database. With this database, the weighting factors used in the algorithm can be refined by using a statistical correlation between the actual sale price and the valuation estimate price. Iterative cross-correlation between the original weighting factors and the database corrected weighting factors improves the accuracy of the valuation estimate model in correctly predicting future sale prices for private equity listings.

The valuation estimate algorithm is based on a summation of qualitative input factors multiplied by weighting factors plus quantitative factors. This is expressed in the following equation:

VE(i)=ΣNqual(i)*Qₖ+ΣNquan(i), with i=1 . . . n

### Where:

VE(i)=the valuation price estimate for the shares of each company (i) listed
Nqual(i)=the numeric weighting factor associated with the qualitative information category, Qₖ, for a company
Nquan(i)=the quantitative factors associated with a company

After many equity valuations and sales have been completed, the valuation estimate algorithm improves through feedback in order to more accurately calculate the final equity sales price. That is, the valuation estimate more closely matches the actual selling price of the equity, such that:

delta=(Valuation estimate−Actual sale price)→0

Since the qualitative information categories, Qₖ, are descriptive (not numeric) they do not change from sale to sale. Only the subjective weighting factor values Nqual(i) can be modified to improve the valuation estimate, VE(i).

Defining the number of equity sales over time as z (where z=1, 2, 3 . . . ) then the complete time varying function for each weighting factor can be described as:

Nqual(i,z)=a(i,0)+∫[dNqual(i,z))/dz]*dz

### Where:

a(i,0)=the initial estimate for a weighting factor, and
(dNqual(i,z))/dz)=the variation of Nqual(i,z) from analysis of delta over a series of security sales

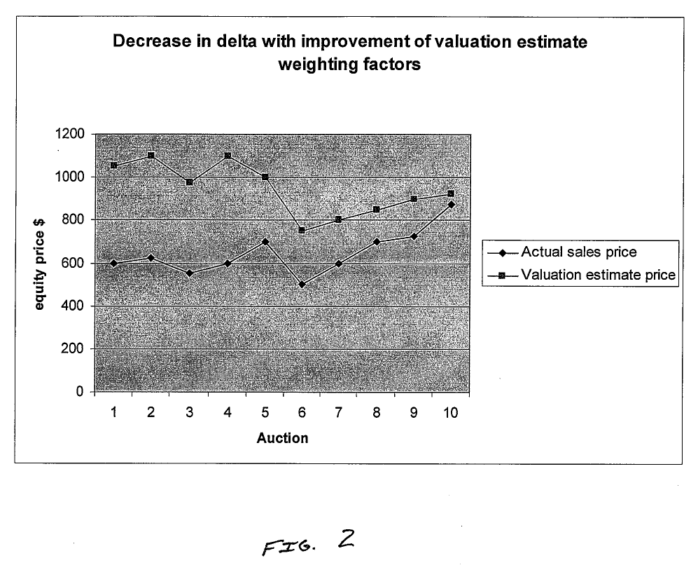

The proficiency of this method is illustrated in FIG. 2. The graph of equity price versus the number of sales shows a decrease in delta, or the difference between the forecasted and actual sales price, as a result of the improvement in the valuation estimate accuracy over time as the values for Nqual(i,z) are modified based upon past sales so as to converge to the actual selling price going forward.

In a further form, a ranking score is calculated with the valuation estimate by normalizing the valuation estimates for each equity within a sector and expressing the ranking as a score from 1 to 100.

Ranking=VE(j)/[ΣVE(j)/n] for j=1 . . . n, (# of equities in the sector)

Turning to another form, a method for providing for the calculation of a valuation estimate and the resale of private limited partnership shares is described. Venture capital companies raise money to invest by selling limited partnerships in a fund. Often the fund is restricted to a certain technology area such as biotechnology. The venture capital firm acts as the general partner. The general partner may stipulate that the limited partners remain invested for a period of five years. However, within that time period, a limited partner may have an unexpected need for the money invested. In that case, the limited partner must appeal to the general partner to buy back the investment.

Since the secondary market for resale of such venture capital private partnership shares is very illiquid, an extraordinary amount of effort is often needed to find a qualified buyer. The general partner may decline the request or may only speak to a few individuals who may be willing to buy out the limited partner, often at a deep discount to the original purchase price. The general partner has no obligation to buy back the shares.

In this example, the limited partner would list their partnership shares for valuation and resale on the networked communication system. The share listing would include factors such as a subset of those illustrated above in Table 1. Preferably, these include: venture fund name, venture fund manager, year of equity purchase, number of shares, original purchase price, industry sector, and other parameters. Qualitative and quantitative factors may be listed. The qualitative factors are converted by the valuation estimate algorithm into quantitative factors with numeric weighting parameters.

One exemplary qualitative factor is the reputation of the venture capital firm that made the original private equity investment. These reputations constitute a “brand name” in the industry. As such they can impart some assurance to the exchange bidder about the value of equity. Likewise the lead venture fund manager may have a reputation that can provide some level of comfort to the prospective buyer.

To convert this qualitative or subjective information into a quantitative weighting factor for the valuation algorithm, industry publications such as the Forbes Midas 100 list or the Price and Waterhouse venture capital survey can be used. These commercial publications rank the top 100 venture capital firms in the United States based on information such as the number of initial public offerings accomplished by the venture firm.

Hence, in the valuation estimate algorithm, the venture capital firm reputation is converted to a quantitative weighting factor by averaging the publication ranking over a period of years and normalizing this value for the matrix of valuation factors. A similar calculation would be repeated for the venture fund manager reputation and other qualitative factors. As is described herein, the algorithm would then utilize these weighted qualitative and quantitative values to calculate a valuation estimate and then rank the venture capital equity within similar technical sector listings.

While the invention has been illustrated and described in detail in the drawings and foregoing description, the same is to be considered as illustrative and not restrictive in character. Only the preferred embodiment, and certain alternative embodiments deemed useful for further illuminating the preferred embodiment, have been shown and described. All changes and modifications that come within the spirit of the invention are desired to be protected.

What is claimed is:

1. A method for providing a valuation estimate and resale of a private equity security comprising the steps of:
receiving a plurality of quantitative and qualitative values associated with the security over a communication network;
storing the plurality of qualitative and quantitative values in a matrix;
performing at least one linear algebraic calculation on the matrix;
converting the matrix to a valuation estimate number;
determining a valuation estimate ranking for the security indicating the value of the security compared to a group of similar private security listings; and
transmitting the valuation estimate number and the valuation estimate ranking to a first user over the communication network.

2. The method of claim 1, wherein a portion of the quantitative and qualitative values are received from a second user.

3. The method of claim 1, wherein a portion of the quantitative and qualitative information is periodically retrieved from an electronic databases and sources.

4. The method of claim 3, wherein the quantitative and qualitative values are comprised of intellectual property data associated with the security.

5. The method of claim 4, wherein the intellectual property data comprises the number of issued patents and patent applications held by the entity associated with the security.

6. The method of claim 5, wherein the intellectual property data further comprises the number of other patents or applications which cite an issued patent or patent application held by the entity associated with the security.

7. The method of claim 5, wherein the intellectual property data further comprises the number of patent licenses granted by the entity associated with the security.

8. The method of claim 3, wherein the quantitative and qualitative values are comprised of venture capital fund data associated with the initial sale of the security by the originating venture fund.

9. The method of claim 8, wherein the venture capital fund data comprises the number of venture fund co-investors, the venture fund rank in industry surveys, the venture fund lead manager rank in industry surveys, number of initial public offerings by the venture fund, number of companies sold through merger or acquisition by the venture fund.

10. The method of claim 3, wherein the quantitative and qualitative values are comprised of university affiliated investor group data associated with the original sale of the security.

11. The method of claim 10, wherein the university affiliated investor group data is comprised of an associated university survey rank, the number of affiliate group original investors, the affiliate group completed initial public offerings, the affiliate group companies sold by merger or acquisition, and the affiliate group news citations.

12. The method of claim 3, wherein the quantitative and qualitative values are comprised of angel investor data associated with the original sale of the security.

13. The method of claim 12, wherein the university affiliated investor group data is comprised of angel group membership in the Angel Capital Association, the number of original investors, the angel group companies sold by merger or acquisition, and the number of angel group news citations.

14. The method of claim 3, wherein the quantitative and qualitative values are comprised of financial data associated with the security.

15. The method of claim 14, wherein the financial data is comprised of the original equity purchase price, the number of outstanding shares, the revenue history, the margin history, the revenue growth rate, the earnings estimate, and the commercial bank prime interest rate.

16. The method of claim 3, wherein the matrix is partially comprised of numeric weighting factors assigned individually to the qualitative values.

17. The method of claim 16, wherein the qualitative values comprise the class of shares offered, the issuing entity restrictions on security sale, the security technology sector, and the published sector rotation prominence associated with the security.

18. The method of claim 16, wherein the numeric weighting factors are modified by a computer implemented statistical correlation algorithm between the final private security resale price and the valuation estimate ranking.

19. The method of claim 1 wherein the resale of the security is accomplished by a sale type selected from the group consisting of a sale at a set price with no time limit, a sale at a set price within a prescribed time limit, a sale within a range of a minimum and maximum price based on the valuation estimate, and a sale at a maximum price above the valuation estimate.

20. The method of claim 1 wherein the private equity security is of the type defined by the United States Securities and Exchange Commission Section D, Rule 144 as restricted shares or limited partnership interests.

21. The method of claim 1 wherein the communication network comprises the World Wide Web.

22. The method of claim 1, wherein the communication network comprises a private intranet.

23. The method of claim 1, wherein the first user is an investor as defined as those allowed to participate in private resales under United States Securities and Exchange Commission Section 4(1) and 4(2).

24. The method of claim 1, wherein the first user is provided a Rule 144 resale opinion letter based on the valuation estimate number.

25. The method of claim 1, further comprising the steps of:
determining a private investor subcategory group; and
displaying the private equities in a sorted fashion based upon the private investor subcategory group.
